(19) United States
(12) Patent Application Publication
(10) Pub. No.: US 2013/0095840 A1
(43) Pub. Date: Apr. 18, 2013

(54) ENHANCEMENT OF DEDICATED RANGING IN RESPONSE TO PAGE MESSAGES FOR A MOBILE STATION

(71) Applicants: Chun Woo Lee, San Ramon, CA (US); Jong Ro Park, Santa Clara, CA (US); Kyoung Cheol Oh, Santa Clara, CA (US); Nitin Pant, San Diego, CA (US); Kuo-Chun Lee, San Diego, CA (US)

(72) Inventors: Chun Woo Lee, San Ramon, CA (US); Jong Ro Park, Santa Clara, CA (US); Kyoung Cheol Oh, Santa Clara, CA (US); Nitin Pant, San Diego, CA (US); Kuo-Chun Lee, San Diego, CA (US)

(73) Assignee: QUALCOMM Incorporated, San Diego, CA (US)

(21) Appl. No.: 13/272,165

(22) Filed: Oct. 12, 2011

(51) Int. Cl. H04W 68/00; H04W 72/04

(52) U.S. Cl. 455/450; 455/458

(57) ABSTRACT

Certain embodiments of the present disclosure present methods and apparatuses for enhancing the dedicated ranging procedure. Certain embodiments improve probability of correct reception of a ranging code from a mobile station by accumulating two or more copies of the ranging code received from the MS on two or more different frames in a transmit opportunity. Certain aspects improve probability of correct reception of the ranging code by modifying timing of uplink transmission.

### TECHNICAL FIELD

Certain embodiments of the present disclosure generally relate to wireless communication and, more particularly to the enhancement of the dedicated ranging in response to the page message for a mobile station.

### BACKGROUND

In a wireless network using WiMAX (Worldwide Interoperability for Microwave Access) technology, when a mobile station (MS) is in idle mode, it listens to the Mobile Paging Advertisement (MOB_PAG-ADV) message from the base station. The base station can page the MS whenever there is downlink (DL) data pending in the network and the MS needs to re-enter the network to resume traffic operation.

When a MS receives the MOB_PAG-ADV message that matches its 48-bit medium access control (MAC) address, the MS may use a ranging procedure to reply. The ranging procedure may include sending a ranging code, receiving a Ranging Response (RNG-RSP) message, and sending a Ranging Request (RNG-REQ) message to reenter the network.

To avoid contention in the initial ranging, a base station (BS) may allocate dedicated ranging resources for each MS.

### SUMMARY

Certain aspects of the present disclosure present a method for wireless communications. The method generally includes transmitting a request to an apparatus to reenter a network, receiving a ranging signal from the apparatus in response to the request, detecting a ranging code from the received ranging signal by combining two or more portions of the received ranging signal, and transmitting a ranging response message to the apparatus based at least on the detected ranging code.

Certain aspects of the present disclosure present a method for wireless communications. The method generally includes receiving a request from an apparatus to reenter a network, transmitting a ranging code to the apparatus using an initial transmission time, adjusting the initial transmission time if a ranging response is not received from the apparatus, and retransmitting the ranging code with the adjusted transmission time.

Certain aspects of the present disclosure present an apparatus for wireless communications. The apparatus generally includes means for transmitting a request to an apparatus to reenter a network, means for receiving a ranging signal from the apparatus in response to the request, means for detecting a ranging code from the received ranging signal by combining two or more portions of the received ranging signal, and means for transmitting a ranging response message to the apparatus based at least on the detected ranging code.

Certain aspects of the present disclosure present an apparatus for wireless communications. The apparatus generally includes means for receiving a request from an apparatus to reenter a network, means for transmitting a ranging code to the apparatus using an initial transmission time, means for adjusting the initial transmission time if a ranging response is not received from the apparatus, and means for retransmitting the ranging code with the adjusted transmission time.

Certain aspects provide a computer-program product for wireless communications, comprising a computer-readable medium having instructions stored thereon, the instructions being executable by one or more processors. The instructions generally include instructions for transmitting a request to an apparatus to reenter a network, instructions for receiving a ranging signal from the apparatus in response to the request, instructions for detecting a ranging code from the received ranging signal by combining two or more portions of the received ranging signal, and instructions for transmitting a ranging response message to the apparatus based at least on the detected ranging code.

Certain aspects provide a computer-program product for wireless communications, comprising a computer-readable medium having instructions stored thereon, the instructions being executable by one or more processors. The instructions generally include instructions for receiving a request from an apparatus to reenter a network, instructions for transmitting a ranging code to the apparatus using an initial transmission time, instructions for adjusting the initial transmission time if a ranging response is not received from the apparatus, and instructions for retransmitting the ranging code with the adjusted transmission time.

Certain aspects of the present disclosure provide an apparatus for wireless communications. The apparatus generally includes at least one processor and a memory coupled to the at least one processor. The at least one processor configured to transmit a request to an apparatus to reenter a network, receive a ranging signal from the apparatus in response to the request, detect a ranging code from the received ranging signal by combining two or more portions of the received ranging signal, and transmit a ranging response message to the apparatus based at least on the detected ranging code, and a memory coupled to the at least one processor.

Certain aspects of the present disclosure provide an apparatus for wireless communications. The apparatus generally includes at least one processor and a memory coupled to the at least one processor. The at least one processor configured to receive a request from an apparatus to reenter a network, transmit a ranging code to the apparatus using an initial transmission time, adjust the initial transmission time if a ranging response is not received from the apparatus, and retransmit the ranging code with the adjusted transmission time, and a memory coupled to the at least one processor.

### BRIEF DESCRIPTION OF THE DRAWINGS

So that the manner in which the above-recited features of the present disclosure can be understood in detail, a more particular description, briefly summarized above, may be had by reference to embodiments, some of which are illustrated in the appended drawings. It is to be noted, however, that the appended drawings illustrate only certain typical embodiments of this disclosure and are therefore not to be considered limiting of its scope, for the description may admit to other equally effective embodiments.

FIG. 1 illustrates an example wireless communication system, in accordance with certain embodiments of the present disclosure.

FIG. 2 illustrates various components that may be utilized in a wireless device in accordance with certain embodiments of the present disclosure.

FIG. 3 illustrates an example transmitter and an example receiver that may be used within a wireless communication system that utilizes orthogonal frequency-division multiplexing and orthogonal frequency division multiple access (OFDM/OFDMA) technology in accordance with certain embodiments of the present disclosure.

FIG. 4 illustrates an example frame structure in WiMAX (Worldwide Interoperability for Microwave Access) standard.

FIG. 5 illustrates example operations for enhancing the dedicated ranging in response to the page messages for a mobile station, in accordance with certain embodiments of the present disclosure.

FIG. 6 illustrates an example of improving the ranging failure caused by the low received signal power, in accordance with certain embodiments of the present disclosure.

FIG. 7 illustrates example operations for improving the ranging failure caused by wrong uplink transmission timing, in accordance with certain embodiments of the present disclosure.

FIG. 8 illustrates an example of improving the ranging failure caused by wrong uplink transmission timing by choosing a large initial timing, in accordance with certain embodiments of the present disclosure.

FIG. 9 illustrates an example of improving the ranging failure caused by wrong uplink transmission timing by choosing a random initial timing, in accordance with certain embodiments of the present disclosure.

FIG. 10 illustrates an example of improving the ranging failure caused by wrong uplink transmission timing by choosing the initial timing as a function of the power loss, in accordance with certain embodiments of the present disclosure.

FIG. 11 illustrates an example communication system, in accordance with certain aspects of the present disclosure.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

### An Example Wireless Communications System

The techniques described herein may be used for various broadband wireless communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

One example of a communication system based on an orthogonal multiplexing scheme is a WiMAX system. WiMAX, which stands for the Worldwide Interoperability for Microwave Access, is a standards-based broadband wireless technology that provides high-throughput broadband connections over long distances. There are two main applications of WiMAX today: fixed WiMAX and mobile WiMAX. Fixed WiMAX applications are point-to-multipoint, enabling broadband access to homes and businesses, for example. Mobile WiMAX is based on OFDM and OFDMA and offers the full mobility of cellular networks at broadband speeds.

IEEE 802.16x is an emerging standard organization to define an air interface for fixed and mobile broadband wireless access (BWA) systems. IEEE 802.16x approved “IEEE P802.16-REVd/D5-2004” in May 2004 for fixed BWA systems and published “IEEE P802.16e/D12 October 2005” in October 2005 for mobile BWA systems. Those two standards defined four different physical layers (PHYs) and one media access control (MAC) layer. The OFDM and OFDMA physical layer of the four physical layers are the most popular in the fixed and mobile BWA areas respectively.

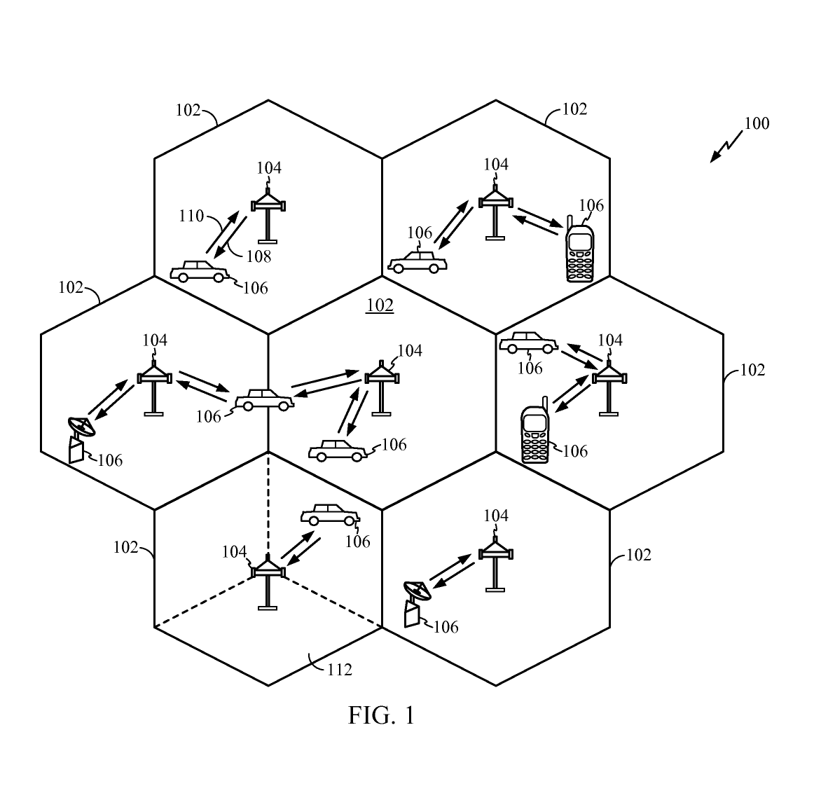

FIG. 1 illustrates an example of a wireless communication system 100. The wireless communication system 100 may be a broadband wireless communication system. The wireless communication system 100 may provide communication for a number of cells 102, each of which is serviced by a base station 104. A base station 104 may be a fixed station that communicates with user terminals 106. The base station 104 may alternatively be referred to as an access point, a Node B, or some other terminology.

FIG. 1 depicts various user terminals 106 dispersed throughout the system 100. The user terminals 106 may be fixed (i.e., stationary) or mobile. The user terminals 106 may alternatively be referred to as remote stations, access terminals, terminals, subscriber units, mobile stations, stations, user equipment, etc. The user terminals 106 may be wireless devices, such as cellular phones, personal digital assistants (PDAs), handheld devices, wireless modems, laptop computers, personal computers (PCs), etc.

A variety of algorithms and methods may be used for transmissions in the wireless communication system 100 between the base stations 104 and the user terminals 106. For example, signals may be sent and received between the base stations 104 and the user terminals 106 in accordance with OFDM/OFDMA techniques. If this is the case, the wireless communication system 100 may be referred to as an OFDM/OFDMA system.

A communication link that facilitates transmission from a base station 104 to a user terminal 106 may be referred to as a downlink 108, and a communication link that facilitates transmission from a user terminal 106 to a base station 104 may be referred to as an uplink 110. Alternatively, a downlink 108 may be referred to as a forward link or a forward channel, and an uplink 110 may be referred to as a reverse link or a reverse channel.

A cell 102 may be divided into multiple sectors 112. A sector 112 is a physical coverage area within a cell 102. Base stations 104 within a wireless communication system 100 may utilize antennas that concentrate the flow of power within a particular sector 112 of the cell 102. Such antennas may be referred to as directional antennas.

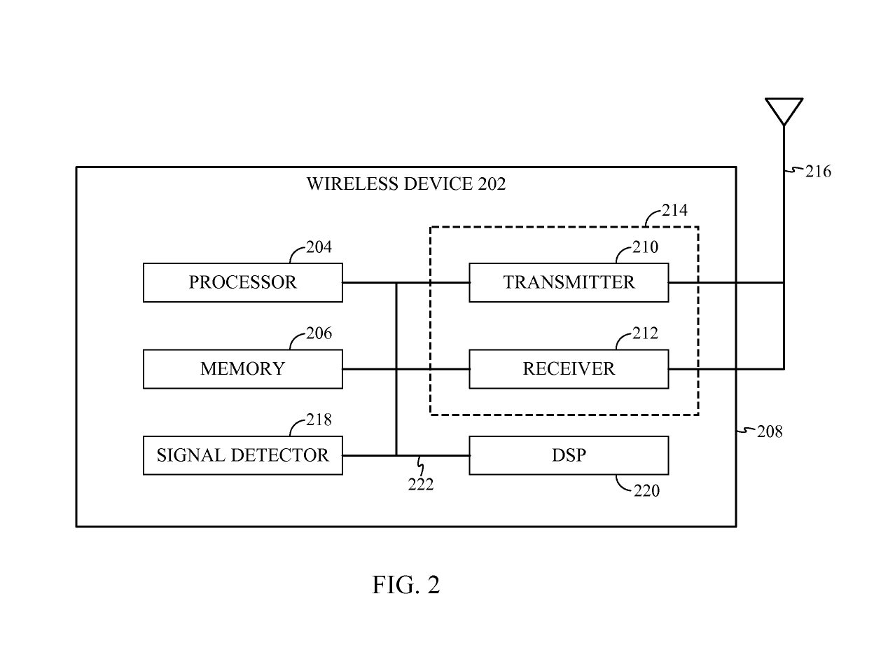

FIG. 2 illustrates various components that may be utilized in a wireless device 202. The wireless device 202 is an example of a device that may be configured to implement the various methods described herein. The wireless device 202 may be a base station 104 or a user terminal 106.

The wireless device 202 may include a processor 204 which controls operation of the wireless device 202. The processor 204 may also be referred to as a central processing unit (CPU). Memory 206, which may include both read-only memory (ROM) and random access memory (RAM), provides instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The wireless device 202 may also include a housing 208 that may include a transmitter 210 and a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas.

The wireless device 202 may also include a signal detector 218 that may be used in an effort to detect and quantify the level of signals received by the transceiver 214. The signal detector 218 may detect such signals as total energy, pilot energy from pilot subcarriers or signal energy from the preamble symbol, power spectral density, and other signals. The wireless device 202 may also include a digital signal processor (DSP) 220 for use in processing signals.

The various components of the wireless device 202 may be coupled together by a bus system 222, which may include a power bus, a control signal bus, and a status signal bus in addition to a data bus.

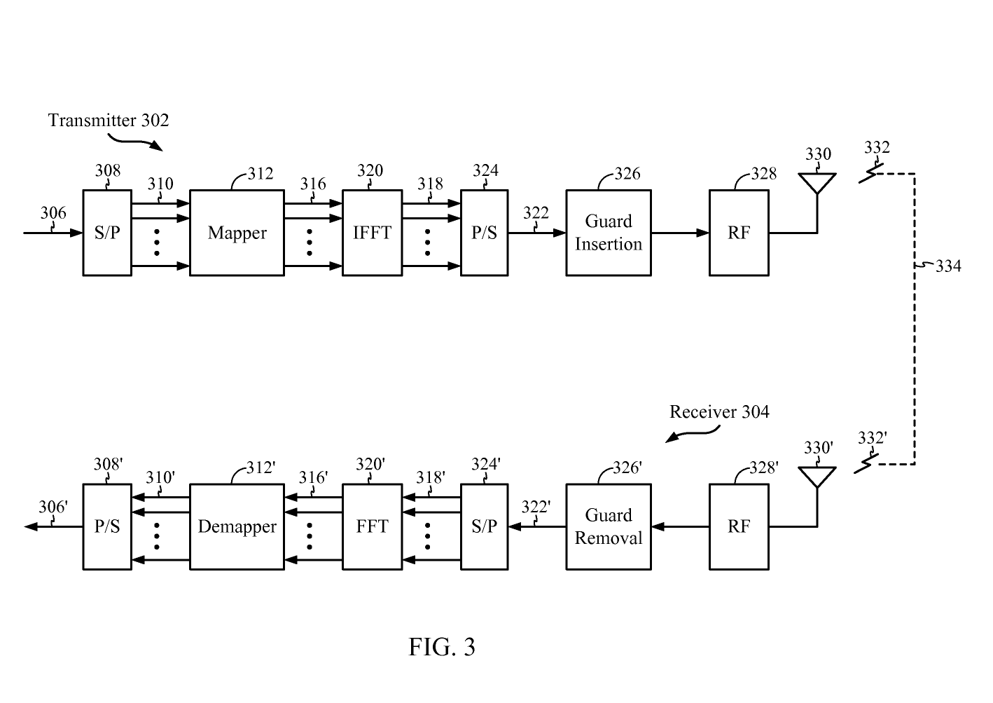

FIG. 3 illustrates an example of a transmitter 302 that may be used within a wireless communication system 100 that utilizes OFDM/OFDMA. Portions of the transmitter 302 may be implemented in the transmitter 210 of a wireless device 202. The transmitter 302 may be implemented in a base station 104 for transmitting data 306 to a user terminal 106 on a downlink 108. The transmitter 302 may also be implemented in a user terminal 106 for transmitting data 306 to a base station 104 on an uplink 110.

Data 306 to be transmitted is shown being provided as input to a serial-to-parallel (S/P) converter 308. The S/P converter 308 may split the transmission data into N parallel data streams 310.

The N parallel data streams 310 may then be provided as input to a mapper 312. The mapper 312 may map the N parallel data streams 310 onto N constellation points. The mapping may be done using some modulation constellation, such as binary phase-shift keying (BPSK), quadrature phase-shift keying (QPSK), 8 phase-shift keying (8PSK), quadrature amplitude modulation (QAM), etc. Thus, the mapper 312 may output N parallel symbol streams 316, each symbol stream 316 corresponding to one of the N orthogonal subcarriers of the inverse fast Fourier transform (IFFT) 320. These N parallel symbol streams 316 are represented in the frequency domain and may be converted into N parallel time domain sample streams 318 by an IFFT component 320.

A brief note about terminology will now be provided. N parallel modulations in the frequency domain are equal to N modulation symbols in the frequency domain, which are equal to N mapping and N-point IFFT in the frequency domain, which is equal to one (useful) OFDM symbol in the time domain, which is equal to N samples in the time domain. One OFDM symbol in the time domain, Nₛ, is equal to N_{cp} (the number of guard samples per OFDM symbol)+N (the number of useful samples per OFDM symbol).

The N parallel time domain sample streams 318 may be converted into an OFDM/OFDMA symbol stream 322 by a parallel-to-serial (P/S) converter 324. A guard insertion component 326 may insert a guard interval between successive OFDM/OFDMA symbols in the OFDM/OFDMA symbol stream 322. The output of the guard insertion component 326 may then be upconverted to a desired transmit frequency band by a radio frequency (RF) front end 328. An antenna 330 may then transmit the resulting signal 332.

FIG. 3 also illustrates an example of a receiver 304 that may be used within a wireless communication system 100 that utilizes OFDM/OFDMA. Portions of the receiver 304 may be implemented in the receiver 212 of a wireless device 202. The receiver 304 may be implemented in a user terminal 106 for receiving data 306 from a base station 104 on a downlink 108. The receiver 304 may also be implemented in a base station 104 for receiving data 306 from a user terminal 106 on an uplink 110.

The transmitted signal 332 is shown traveling over a wireless channel 334. When a signal 332′ is received by an antenna 330′, the received signal 332′ may be downconverted to a baseband signal by an RF front end 328′. A guard removal component 326′ may then remove the guard interval that was inserted between OFDM/OFDMA symbols by the guard insertion component 326.

The output of the guard removal component 326′ may be provided to an S/P converter 324′. The S/P converter 324′ may divide the OFDM/OFDMA symbol stream 322′ into the N parallel time-domain symbol streams 318′, each of which corresponds to one of the N orthogonal subcarriers. A fast Fourier transform (FFT) component 320′ may convert the N parallel time-domain symbol streams 318′ into the frequency domain and output N parallel frequency-domain symbol streams 316′.

A demapper 312′ may perform the inverse of the symbol mapping operation that was performed by the mapper 312, thereby outputting N parallel data streams 310′. A P/S converter 308′ may combine the N parallel data streams 310′ into a single data stream 306′. Ideally, this data stream 306′ corresponds to the data 306 that was provided as input to the transmitter 302.

### An Example Enhancement of Dedicated Ranging

Certain embodiments of the present disclosure present methods and apparatuses for enhancing the dedicated ranging procedure. Certain embodiments improve probability of correct reception of a ranging code from a mobile station (MS) by accumulating two or more copies of the ranging code received from the MS on two or more different frames in a transmit opportunity. Certain aspects improve probability of correct reception of the ranging code by modifying timing of uplink transmission.

When a mobile station is in idle mode (e.g., in a system using WiMAX standard), the MS may listen to the broadcast page messages (e.g., MOB_PAG-ADV) from a base station. The base station may page the MS whenever there is downlink (DL) data for the MS that is pending in the network. The MS may re-enter the network in response to the paging and may resume traffic operations.

If the MS receives a MOB_PAG-ADV message that matches its 48-bit medium access control (MAC) address, the MS may use a ranging procedure to reply to the base station. The ranging procedure may include sending a ranging code, receiving a Ranging Response (RNG-RSP) message, and sending a Ranging Request (RNG-REQ) message to reenter the network.

To avoid contention in the initial ranging, the base station (BS) may allocate dedicated ranging resources for each MS. However, dedicated ranging is very expensive in terms of bandwidth, since portions of the available bandwidth are uniquely allocated to each MS. In addition, all of the base stations in a paging group may need to allocate such dedicated resources although each MS can only communicate with one of the BSs in the paging group.

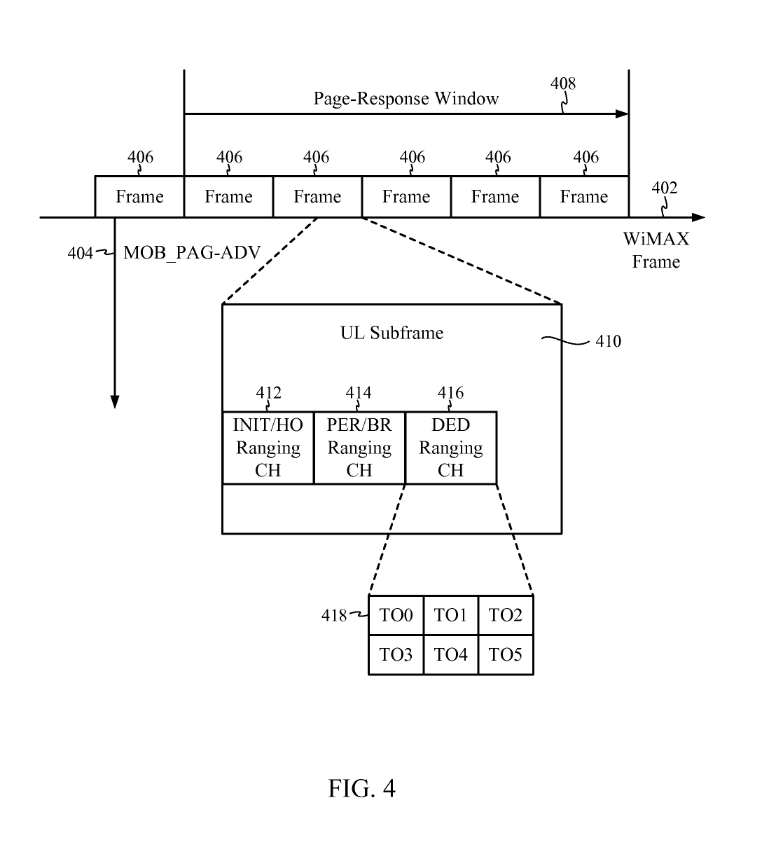

FIG. 4 illustrates a frame structure 402 in the WiMAX standard. When a MS receives a paging message (e.g., Mobile Paging Advertisement (MOB_PAG-ADV)) 404 that matches its 48-bit Media Access Control (MAC) address, the MS may use a ranging procedure to reply to the message. The ranging procedure may include sending a ranging request (e.g., a ranging code), receiving a ranging response, and the like.

To avoid contention in initial ranging, a BS may allocate dedicated ranging resources to a MS. In the uplink (UL) subframe 410, the BS may allocate three separate ranging regions: initial and handover region 412, periodic and bandwidth request region 414, and dedicated ranging region 416. The BS may send a MOB_PAG-ADV message 404 to notify the MS of the resources available in dedicated ranging region 416. These resources may include a Code Division Multiple Access (CDMA) code, assigned transmission opportunity (TO) 418, and length of a Page-Response Window 408.

The MS may perform ranging in the dedicated ranging region 416, starting from the next frame 406 after receiving the MOB_PAG-ADV message. The MS may use the assigned CDMA code to continuously transmit on the assigned TO 418 in the dedicated ranging region 416 for the next few frames 406 that fit into the Page-Response Window 408.

However, dedicated ranging may be very expensive in terms of bandwidth. Because in dedicated ranging certain amount of bandwidth is uniquely allocated for each MS. All the base stations in a paging group may need to allocate such dedicated resources to the MS although the MS may only communicate with one of the base stations in the paging group.

The present disclosure proposes two methods to improve success of dedicated ranging and reduce the resources that can be assigned for dedicated ranging.

### Improving Ranging Failure Caused by a Low Received Signal Power

For certain embodiments of the present disclosure, probability of ranging failure because of low received signal power may be reduced by accumulating ranging signals received in different frames. When the BS is unable to detect a ranging code received from the MS in a single frame, the BS may accumulate the ranging signals received on the same transmit opportunity (TO) for different frames in a Page-Response Window for each subcarrier. The BS may continue accumulating the ranging signals until the base station is able to successfully decode the ranging code.

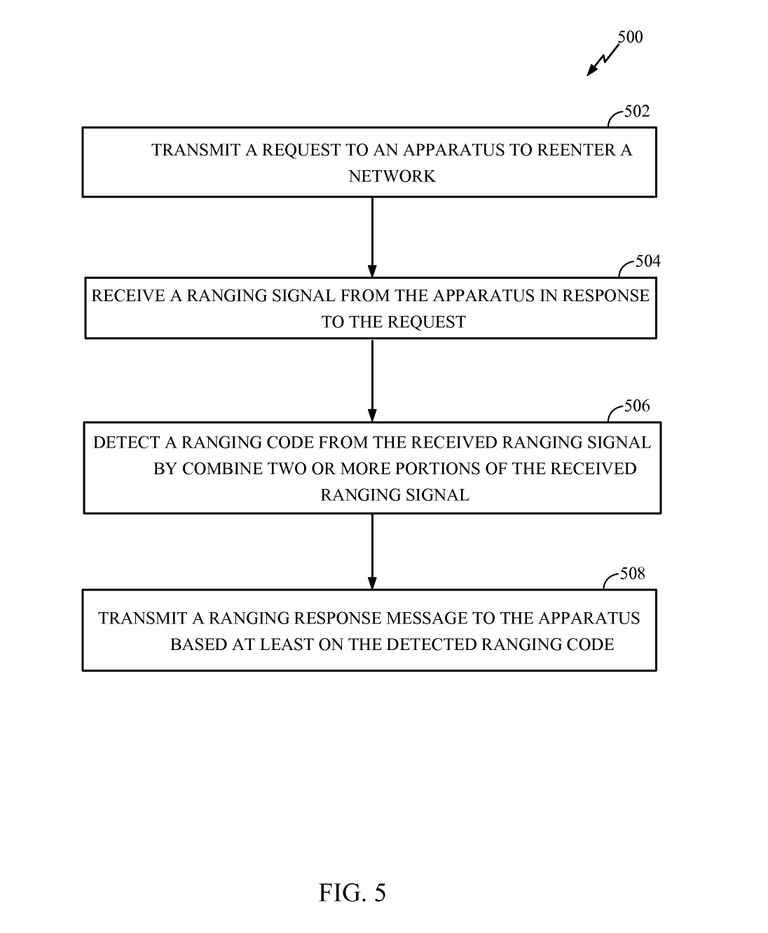

FIG. 5 illustrates example operations 500 for improving the ranging failure that may be caused by low received signal power. At 502, a base station may transmit a request to an apparatus (e.g., a MS) to reenter a network. The request message may include information about the dedicated resources (e.g., a code division multiple access (CDMA) code, an assigned transmission opportunity, and a paging response window) to be used for generating and transmitting the ranging signal using dedicated ranging procedure. At 504, the BS may receive a ranging signal from the MS in response to the request. At 506, the BS may detect a ranging code from the received ranging signal by combining two or more portions of the received ranging signal. For example, the BS may combine two or more portions of the ranging signal that are received on dedicated transmit opportunities of two or more frames, and detecting the ranging code from the combined signal. At 508, the BS may transmit a ranging response message to the MS based at least on the detected ranging code. The BS may also calculate a power adjustment value for the MS based at least on the number of portions of the received ranging signal being combined and transmit the power adjustment value in the ranging response message.

By linearly combing received symbols of each corresponding subcarrier in previous frames and the current frame, signal-to-noise ratio (SNR) may be increased. As a result, the BS may be able to detect the ranging code successfully. The method described herein may compensate effects of fading or path-loss on the received signal.

For certain embodiments of the present disclosure, in order to correctly adjust the transmission power (P_adj) of the MS, the BS may include an offset value of log(M) in the post-combining power adjustment P_adj_combine. Therefore, P_adj may be calculated as follows:

P_adj=P_adj_combine+log(M) in dB (1)

where M may represent number of symbols that are combined.

For certain embodiments, the MS may use the highest power available for its radio frequency (RF) power amplifier to transmit in the dedicated ranging region. For another embodiment, the MS may transmit with a higher power than the downlink power loss. Therefore, transmission power P of the MS may be written as follows:

P=min{BS_{—}EIRP−S+A, MS_max_power} (2)

where the BS_EIRP may represent the effective isotropic radiation power of the BS which is known from the downlink channel descriptor (DCD) message, S may represent the received power of a signal transmitted by the BS to the MS, A may represent amount of power that compensates the downlink power loss, and the MS_max_power may represent the maximum transmission power available to the MS.

For certain embodiments, the MS may continue transmitting uplink ranging codes with the same timing until a ranging response message is received. Otherwise, the serving BS may receive ranging codes from the MS with different timings and the serving BS may not be able to combine the ranging codes correctly.

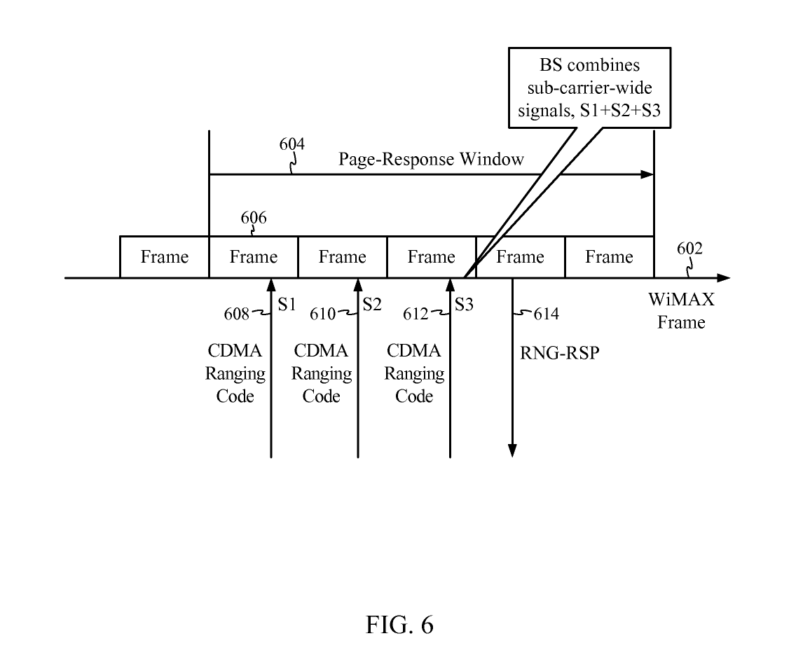

FIG. 6 illustrates an example embodiment for improving the received power through combining of ranging code signals received in the dedicated ranging process. The Figure shows one or more frames (for example, WiMAX frame 602) that are transmitted in time. A MS may transmit one or more frames 606 in a Page-Response window 604. During the dedicated ranging, a MS may transmit a plurality of frames 606 in the Page_Response_Window, until the MS receives the RNG_RSP message 614. For certain embodiments, if the BS is not able to decode the ranging code, the BS may combine the CDMA ranging code signals (e.g., S1, 608, S2, 610 and S3, 612) from different frames. By improving the signal to noise ratio through combining, the BS may be able to detect the ranging code and send a RNG-RSP message 614 to the MS.

### Improving Ranging Failure Caused by Wrong UL Transmission Timing

Certain embodiments reduce the ranging failure that is caused by wrong uplink transmission timing In this method, the MS may try different uplink transmission timing values while sending ranging codes.

A BS may send a RNG-RSP message a fixed number of frames (i.e., k) after receiving a ranging code from the MS. The parameter k may be known by both the MS and the BS. Because the RNG-RSP message includes timing adjustment information, the RNG-RSP message should clearly refer to the corresponding ranging code transmission.

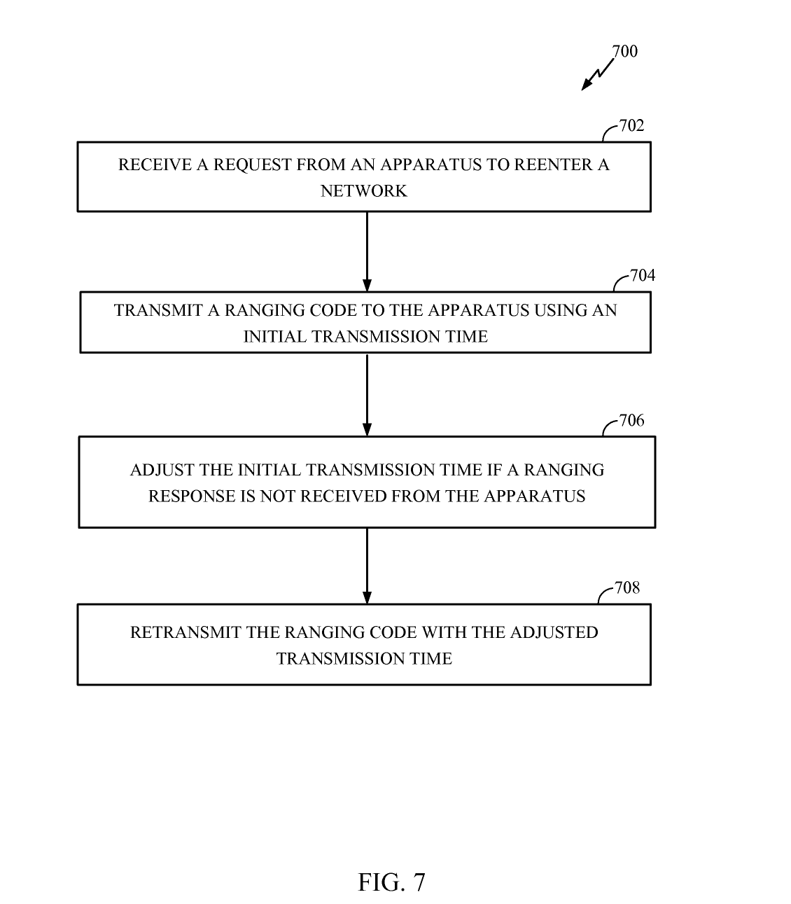

FIG. 7 illustrates example operations 700 for improving the ranging failure caused by wrong uplink transmission timing in accordance with certain embodiments of the present disclosure. At 702, a MS may receive a request from an apparatus (e.g., a base station) to reenter a network. At 704, the MS may transmit a ranging code to the BS using an initial transmission time (e.g., D). The MS may receive a ranging response message in a frame from the BS, in which the frame is transmitted a fixed number of frames after reception of the ranging code. At 706, the MS may adjust the initial transmission time if a ranging response is not received from the BS. For example, the MS may select an adjustment value and add the adjustment value to the initial transmission time to obtain the adjusted transmission time. At 708, the MS may retransmit the ranging code with the adjusted transmission time.

For certain embodiments of the present disclosure, the initial timing value D(1) may be selected as a large number, which may imply that D(1) being set for a UL transmission timing as if the MS was close to the BS. Then, if the MS does not receive a RNG-RSP message, the MS may adjust its uplink transmission timing in the k^{th} transmission by the following equation:

D(k)=max{D(1)−(k−1)*Δ, Dₘᵢₙ}, k=2, 3, . . . (3)

where Dₘᵢₙ may represent minimum value of the transmission timing. In the above equation, a subtraction by Δ may mean that the MS may be farther away from the BS.

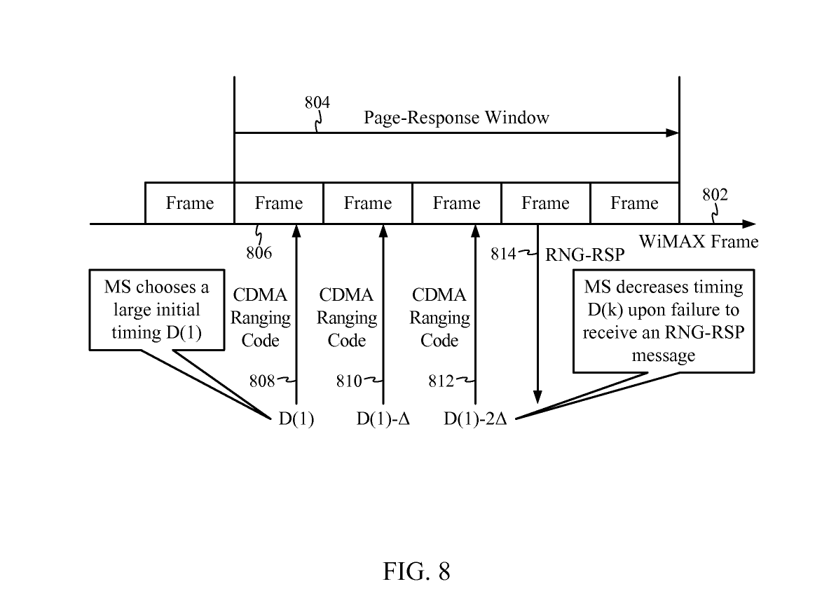

FIG. 8 illustrates an example embodiment for the timing adjustment by choosing a large initial timing value for the ranging code transmission. The Figure shows one or more frames (for example, WiMAX frames 802) that are transmitted in time. A MS may transmit one or more frames 806 in a Page-Response window 804. The MS may start transmitting the ranging code with a large initial timing value D(1) at 808. If the MS does not receive a ranging response (RNG-RSP) message, the MS may decrease the initial value of D(1) by Δ for the next frame 810. The MS may continue decreasing the timing value by Δ (e.g., decreasing the initial value by 2Δ in 812). The MS may retransmit the each of the frames with the adjusted timing. The BS may be able to detect the ranging code from the received frames and may send the RNG-RSP message 814 to the MS.

For certain embodiments of the present disclosure, the initial timing value D(1) may be selected as a small value, which may imply that the MS is far from the BS. If the MS does not receive a RNG-RSP message, the MS may adjust UL transmission timing in the k^{th} transmission using the following equation:

D(k)=max{D(1)+(k−1)*Δ, Dₘₐₓ}, k=2, 3, . . . (4)

where Dₘₐₓ may represent maximum value of the transmission timing. Note that an addition with Δ may mean that the MS may be closer to the BS.

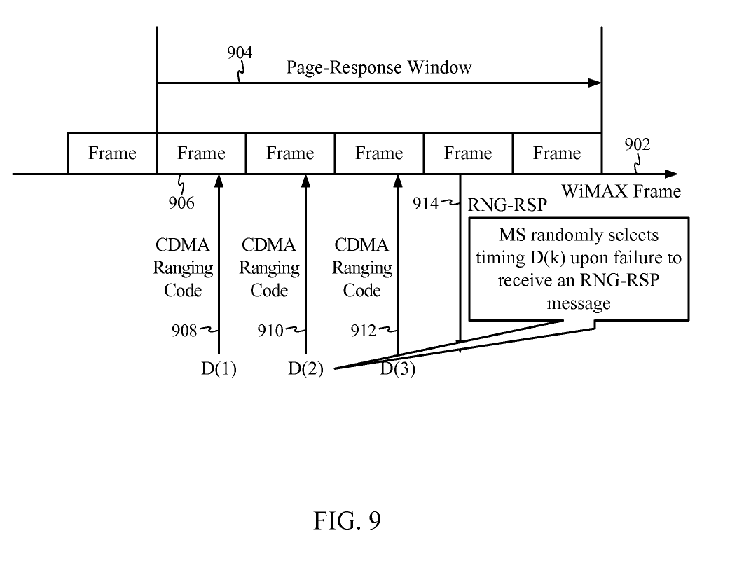

FIG. 9 illustrates an example embodiment for the timing adjustment by choosing a small initial timing value for the ranging code transmission. The Figure shows one or more frames (for example, WiMAX frame 902) that are transmitted in time. A MS may transmit one or more frames 906 in a Page-Response window 904. The MS may start transmitting the ranging code with a small initial timing value D(1) at 908. In the next couple of frames, if the MS has not received the RNG-RSP message, the MS may randomly select the initial value of D(2) and D(3) in 910 and 912, respectively. The MS may also retransmit the corresponding frames. The BS may be able to detect the ranging code and may send the RNG-RSP message 914 to the MS.

For certain embodiments of the present disclosure, the initial timing value D(1) may be chosen randomly. If the MS does not receive a ranging response (RNG-RSP) message, the MS may choose another random value for the transmission timing within a predefined range between Dₘᵢₙ and Dₘₐₓ.

For certain embodiments of the present disclosure, the initial timing value D(1) may be chosen as a function of the power loss in downlink transmission, D(1)=f(L). The downlink power loss L may be calculated as follows:

L=BS_{—}EIRP−S, (5)

where BS_EIRP may represent the effective isotropic radiation power of the BS, which is known from the DCD message, and S may represent the measured received power at the MS. In particular, the larger the L, the smaller the D(1). This may mean that a large signal loss may result an early transmission by the MS. If the MS does not receive a RNG-RSP message, the MS may adjust uplink transmission timing at the k^{th} transmission by D(k)=D(1)+Δ, k=2, 3, . . . , where Δ is randomly selected from a range between Dₘᵢₙ and Dₘₐₓ each time for the subsequent transmissions.

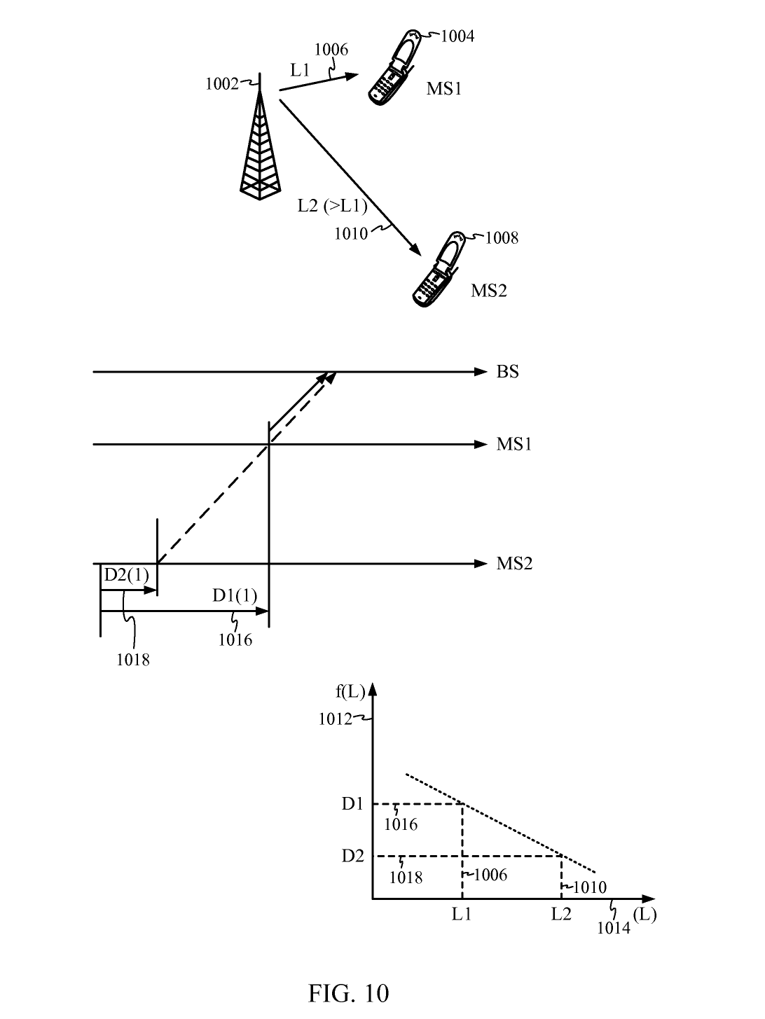

FIG. 10 illustrates an example timing adjustment by the MS with respect to the downlink transmission power loss. A base station 1002 communicates with two mobile stations MS1 1004 and MS2 1008. The distance L1 1006 between the BS and MS1 1004 is smaller than the distance L2 1010 between the BS and MS2 1008. Therefore, the initial timing value D1(1) 1016 for MS1 may be larger than the initial timing value D2(1) 1018. The timing values D1 1016 and D2 1018 may be derived as a function of L 1014 (e.g., using a linear function f(L) 1012).

The proposed disclosure may improve the success probability of the dedicated ranging. It may also decrease the delay of dedicated ranging in response to the BS broadcast page message, increase the efficiency of the ranging channel, and reduce the response time after receiving downlink data in the idle mode.

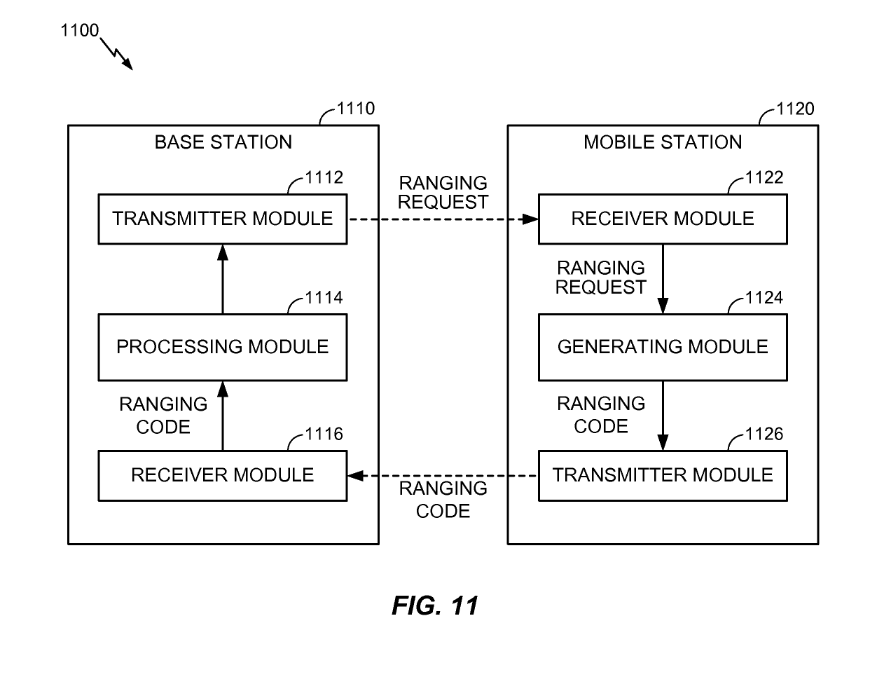

FIG. 11 illustrates an example communication system 1100, in accordance with certain aspects of the present disclosure. As illustrated, the communication system may include a base station 1110 and a MS 1120. The base station may transmit paging request to the MS using the transmitter module 1112. The MS may receive the paging request from the base station with a receiver module 1122. A ranging signal generating module 1124 may generate a ranging signal. The transmitter module 1126 may transmit the ranging signal to the base station. The receiver module 1116 may receive the ranging signal. A processing module 1114 may process the ranging signal and detect a paging code. A transmitter module 1112 may transmit a ranging response message to the mobile station.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for wireless communications, comprising:
transmitting a request to an apparatus to reenter a network;
receiving a ranging signal from the apparatus in response to the request;
detecting a ranging code from the received ranging signal by combining two or more portions of the received ranging signal; and
transmitting a ranging response message to the apparatus based at least on the detected ranging code.

2. The method of claim 1, wherein the request comprises dedicated resources to be used for generating and transmitting the ranging signal using dedicated ranging procedure.

3. The method of claim 2, wherein the dedicated resources comprise a code division multiple access (CDMA) code, an assigned transmission opportunity, and a paging response window.

4. The method of claim 1, wherein detecting the ranging code from the received ranging signal comprises:
combining the two or more portions of the ranging signal that are received on dedicated transmit opportunities of two or more frames; and
detecting the ranging code from the combined signal.

5. The method of claim 1, further comprising:
calculating a power adjustment value for the apparatus based at least on number of portions of the received ranging signal being combined; and
transmitting the power adjustment value in the ranging response message.

6. A method for wireless communications, comprising:
receiving a request from an apparatus to reenter a network;
transmitting a ranging code to the apparatus using an initial transmission time;
adjusting the initial transmission time if a ranging response is not received from the apparatus; and
retransmitting the ranging code with the adjusted transmission time.

7. The method of claim 6, wherein the initial transmission time is a function of downlink power loss.

8. The method of claim 6, wherein adjusting the initial transmission time comprises:
selecting an adjustment value; and
adding the adjustment value to the initial transmission time to obtain the adjusted transmission time.

9. The method of claim 8, wherein the adjustment value is selected randomly.

10. The method of claim 6, further comprising:
receiving a ranging response message in a frame, wherein the frame is transmitted by the apparatus a fixed number of frames after reception of the ranging code.

11. An apparatus for wireless communications, comprising:
means for transmitting a request to an apparatus to reenter a network;
means for receiving a ranging signal from the apparatus in response to the request;
means for detecting a ranging code from the received ranging signal by combining two or more portions of the received ranging signal; and
means for transmitting a ranging response message to the apparatus based at least on the detected ranging code.

12. The apparatus of claim 11, wherein the request comprises dedicated resources to be used for generating and transmitting the ranging signal using dedicated ranging procedure.

13. The apparatus of claim 12, wherein the dedicated resources comprise a code division multiple access (CDMA) code, an assigned transmission opportunity, and a paging response window.

14. The apparatus of claim 11, wherein the means for detecting the ranging code from the received ranging signal comprises:
means for combining the two or more portions of the ranging signal that are received on dedicated transmit opportunities of two or more frames; and
means for detecting the ranging code from the combined signal.

15. The apparatus of claim 11, further comprising:
means for calculating a power adjustment value for the apparatus based at least on number of portions of the received ranging signal being combined; and
means for transmitting the power adjustment value in the ranging response message.

16. An apparatus for wireless communications, comprising:
means for receiving a request from an apparatus to reenter a network;
means for transmitting a ranging code to the apparatus using an initial transmission time;
means for adjusting the initial transmission time if a ranging response is not received from the apparatus; and
means for retransmitting the ranging code with the adjusted transmission time.

17. The apparatus of claim 16, wherein the initial transmission time is a function of downlink power loss.

18. The apparatus of claim 16, wherein the means for adjusting the initial transmission time comprises:
means for selecting an adjustment value; and
means for adding the adjustment value to the initial transmission time to obtain the adjusted transmission time.

19. The apparatus of claim 18, wherein the adjustment value is selected randomly.

20. The apparatus of claim 16, further comprising:
means for receiving a ranging response message in a frame, wherein the frame is transmitted by the apparatus a fixed number of frames after reception of the ranging code.

21. A computer-program product for wireless communications, comprising a non-transitory computer readable medium having instructions stored thereon, the instructions being executable by one or more processors and the instructions comprising:
instructions for transmitting a request to an apparatus to reenter a network;
instructions for receiving a ranging signal from the apparatus in response to the request;
instructions for detecting a ranging code from the received ranging signal by combining two or more portions of the received ranging signal; and
instructions for transmitting a ranging response message to the apparatus based at least on the detected ranging code.

22. A computer-program product for wireless communications, comprising a non-transitory computer readable medium having instructions stored thereon, the instructions being executable by one or more processors and the instructions comprising:
instructions for receiving a request from an apparatus to reenter a network;
instructions for transmitting a ranging code to the apparatus using an initial transmission time;
instructions for adjusting the initial transmission time if a ranging response is not received from the apparatus; and
instructions for retransmitting the ranging code with the adjusted transmission time.

23. An apparatus for wireless communications, comprising at least one processor configured to:
transmit a request to an apparatus to reenter a network,
receive a ranging signal from the apparatus in response to the request,
detect a ranging code from the received ranging signal by combining two or more portions of the received ranging signal, and
transmit a ranging response message to the apparatus based at least on the detected ranging code; and
a memory coupled to the at least one processor.

24. An apparatus for wireless communications, comprising at least one processor configured to:
receive a request from an apparatus to reenter a network,
transmit a ranging code to the apparatus using an initial transmission time,
adjust the initial transmission time if a ranging response is not received from the apparatus, and
retransmit the ranging code with the adjusted transmission time; and
a memory coupled to the at least one processor.
